(19) United States
(12) Patent Application Publication
(10) Pub. No.: US 2026/0261164 A1
(43) Pub. Date: Sep. 3, 2026

(54) Stator for an Axial Flux Machine, Axial Flux Machine, and Motor Vehicle Having an Axial Flux Machine

(71) Applicant: Schaeffler Technologies AG & Co. KG, Herzogenaurach (DE)

(72) Inventor: Marco Mechi, Rosignano Marittimo (LI) (IT)

(73) Assignee: Schaeffler Technologies AG & Co. KG, Herzogenaurach (DE)

(21) Appl. No.: 18/877,656

(22) PCT Filed: Jun. 21, 2023
(86) PCT No.: PCT/EP2023/066772

§ 371 Date: Dec. 20, 2024

(30) Foreign Application Priority Data
Jun. 22, 2022 (DE) 10 2022 206 234.5

(51) Int. Cl. H02K 1/14; H02K 1/18; H02K 3/28

(52) U.S. Cl. CPC H02K 1/146; H02K 1/182; H02K 3/28

(57) ABSTRACT

Teachings of the present disclosure include a stator comprising: an annular tooth holder with an end face having at least two openings to receive one stator tooth each, an outer lateral surface joined to the end face, and a bridge guide formed on an outwardly directed outer face of the outer lateral surface in the radial direction of the tooth holder; two stator teeth arranged, at least in portions, in respective openings, wherein each stator tooth has a core and a winding wound onto the core and at least one winding end guided in the radial direction of the tooth holder above the outer lateral surface; and an electrically conductive bridge arranged in the bridge guide to electrically connect the winding end of the respective stator tooth to the winding end of the further stator tooth.

### CROSS-REFERENCE TO RELATED APPLICATIONS

This application is a U.S. National Stage Application of International Application No. PCT/EP2023/066772 filed Jun. 21, 2023, which designates the United States of America, and claims priority to DE Application No. 10 2022 206 234.5 filed Jun. 22, 2022, the contents of which are hereby incorporated by reference in their entirety.

### TECHNICAL FIELD

The present disclosure relates to electrical machines. Various embodiments of the teachings herein include stators for an axial flux machine, axial flux machines, and motor vehicles.

### BACKGROUND

Stators for axial flux machines usually have a tooth holder and a plurality of stator teeth arranged in the tooth holder. The interconnection of the stator teeth is controlled differently.

### SUMMARY

It is useful to simplify the construction of electric machines, with a particular focus on the simplified manufacture of the electric machine. The teachings of the present disclosure include a stator for an electric machine, which stator can be produced in a simple manner.

For example, some embodiments of the teachings herein include a stator (ST) for an axial flux machine (AFM) of a motor vehicle (KFZ), having an annular tooth holder (ZH), which has an end face (SS) with at least two openings (OE) for receiving one stator tooth (SZ) each and has an outer lateral surface (MF) which is joined to the end face (SS), and at least one bridge guide (BF) is formed, at least in portions, on an outwardly directed outer face (AS) of the outer lateral surface (MF) in the radial direction of the tooth holder (ZH), at least two stator teeth (SZ), of which in each case one is arranged, at least in portions, in one of the openings (OE), wherein each stator tooth (SZ) has a core (KE) and a winding (WI) which is wound onto the core (KE) and has at least one winding end (WE), and the respective winding end (WE) is guided in the radial direction of the tooth holder (ZH) until it is above the outer lateral surface (MF), and an electrically conductive bridge (BR), which is arranged in the bridge guide (BF), for electrically connecting the winding end (WE) of the stator tooth (SZ) to the winding end (WE) of the further stator tooth (SZ).

In some embodiments, the bridge guide (BF) is of U-shaped and/or L-shaped form.

In some embodiments, the tooth holder (ZH) is formed in one piece. In some embodiments, the tooth holder (ZH) is formed, at least in portions, from a plastic.

In some embodiments, the outer lateral surface (MF) has at least one slot (SL) on a side which faces away from the end face (SS) and the winding end (WE) is guided in the slot (SL).

In some embodiments, a further bridge guide (BF) is formed on the outer face (AS) and is formed in a manner spaced apart from the bridge guide (BF) in the radial direction of the tooth holder (ZH). In some embodiments, a further electrically conductive bridge (BR) is arranged in the further bridge guide (BF) and provides an electrically conductive connection to at least one further winding end (WE) of the winding (WI).

In some embodiments, at least one centring and/or fixing projection (ZV), which is formed in the radial direction, is formed on the outer face (AS).

In some embodiments, the stator (ST) has a housing (GE) and the tooth holder (ZH) is arranged in the housing (GE), wherein the tooth holder (ZH) is arranged in the housing (GE) in a manner fixed in terms of position and rotation by means of the at least one centring and/or fixing projection (ZV).

In some embodiments, an annular space (RR) between an inner lateral surface of the housing (GE) and the outer lateral surface (MF) of the tooth holder (ZH) is potted with a potting material (VM).

As another example, some embodiments include an axial flux machine (AFM) for a motor vehicle (KFZ) as described herein.

As another example, some embodiments include a motor vehicle (KFZ) having an axial flux machine (AFM) as described herein.

### BRIEF DESCRIPTION OF THE DRAWINGS

Further features and advantages of teachings of the present disclosure emerge from the subclaims and the following exemplary embodiments. The exemplary embodiments are not to be understood as restrictive, but rather as given by way of example. They are intended to enable a person skilled in the art to implement the teachings herein. The exemplary embodiments will be discussed in more detail with reference to drawings, in which:

FIG. 1 shows a three-dimensional view of an example stator incorporating teachings of the present disclosure;

FIG. 2 shows a view of a detail of the stator in the region of a bridge guide;

FIG. 3 shows a view of a detail of the stator in the region of a centring projection;

FIG. 4 shows a section through the stator having a housing; and

FIG. 5 shows an example motor vehicle having an example axial flux machine incorporating teachings of the present disclosure.

### DETAILED DESCRIPTION

Some embodiments of the teachings herein include a stator for an axial flux machine of a motor vehicle, having an annular tooth holder, which has an end face with at least two openings for receiving one stator tooth each and has an outer lateral surface which is joined to the end face, and at least one bridge guide is formed, at least in portions, on an outwardly directed outer face of the outer lateral surface in the radial direction of the tooth holder, at least two stator teeth, of which in each case one is arranged, at least in portions, in one of the openings, wherein each stator tooth has a core and a winding which is wound onto the core and has at least one winding end, and the respective winding end is guided in the radial direction of the tooth holder until it is above the outer lateral surface, and an electrically conductive bridge, which is arranged in the bridge guide, for electrically connecting the winding end of the stator tooth to the winding end of the further stator tooth.

In some embodiments, the axial flux machine is designed and/or formed to at least partially electrically drive a motor vehicle. The stator has an annular tooth holder. The tooth holder comprises an end face and an outer lateral surface which is joined to the end face and runs in the circumferential direction of the tooth holder. The end face and the outer lateral surface are consequently connected to each other. The end face and the outer lateral surface are particularly preferably formed in one piece and particularly preferably in one production process. Therefore, the structural rigidity of the tooth holder can be increased. The end face has at least two openings, wherein the respective opening is formed for receiving a stator tooth. The outer lateral surface has an outer face, which is directed outwardly in relation to the radial direction of the tooth holder. A bridge guide is formed, at least in portions, on the outer face. Furthermore, the stator has at least two stator teeth. From amongst the two stator teeth, in each case one stator tooth is arranged in one of the openings or engages, at least in portions and/or partially, in the opening. The opening may be formed such that it is closed at the edge and passes through the end face. Each stator tooth has a core and a winding which is wound onto the core and has at least one winding end. The respective winding end is guided in the radial direction of the tooth holder until it is above the outer lateral surface. An electrically conductive bridge for electrically connecting the winding end of the stator tooth to the winding end of the further stator tooth is arranged in the bridge guide, which is formed on the outer face of the tooth holder. The electrically conductive bridge is positioned and/or fixed on the outer face of the tooth holder by means of the bridge guide, so that the electrically conductive bridge is held fixed in terms of position for a connection operation with the winding end of the winding. This may have an advantageous effect on the production process.

In some embodiments, the bridge guide is of U-shaped and/or L-shaped form. In the case of a U-shaped bridge guide, the two webs are aligned in the radial direction of the tooth holder and the “U” is open to the outside in the radial direction of the tooth holder. Therefore, the electrically conductive bridge can be inserted, and preferably in particular clamped, into the “U”, or between the upright webs of the U-shaped bridge guide. It is conceivable that the U-shaped configuration of the bridge guide is mounted onto the outer face and/or incorporated into the outer face. In the case of an L-shaped configuration of the bridge guide, it is provided that the short or the long web in the radial direction of the tooth holder is joined to the outer face, and the respectively other web may be oriented parallel to the longitudinal direction of the circular tooth holder, so that the electrically conductive bridge can be inserted and clamped between the outer face and the respectively other web in parallel to the longitudinal direction of the tooth holder. Therefore, a bridge guide which can be produced in a simple manner and at reasonable cost and allows the electrical bridge to be fixed in a simple and straightforward manner is specified.

In some embodiments, the tooth holder is formed in one piece. “In one piece” means that the tooth holder and the bridge guide are produced as one part. The tooth holder and the bridge guide are therefore connected to each other in a captive manner. The one-piece form of the tooth holder can be created by one working and/or production process on the tooth holder. The tooth holder can therefore be produced at reasonable cost.

In some embodiments, the tooth holder is formed, at least in portions, from a plastic. The tooth holder may be formed entirely from a plastic. The plastic may be a thermal plastic or a thermoset. The tooth holder can therefore be produced at reasonable cost, e.g. using an injection-molding process or transfer-molding process.

In some embodiments, the plastic has a fiber reinforcement and/or a matrix. The fiber reinforcement may be a glass-fiber reinforcement or a carbon-fiber reinforcement. In comparison to carbon, glass fiber has the advantage that it has better thermal properties and therefore does not lead to an accumulation of heat within the tooth holder. Therefore, the fiber can not only increase the structural rigidity, but also provide better thermal conductivity of the tooth holder, depending on the choice of fiber. In some embodiments, the outer lateral surface has at least one slot on a side which faces away from the end face and the winding end is guided in the slot. In this way, the winding end of the winding can be guided in a simple and space-saving manner through the lateral surface until it is above the outer face, in order to be connected to the electrical bridge there.

In some embodiments, a further bridge guide is formed on the outer face and is formed in a manner spaced apart from the bridge guide in the radial direction of the tooth holder. It is also conceivable that the further bridge guide is formed, at least in portions, maybe completely, offset in relation to the bridge guide. In some embodiments, a further electrically conductive bridge is arranged in the further bridge guide and provides an electrically conductive connection to at least one further winding end of the winding. Owing to the further bridge guide, it is possible to fix the further electrical bridge on the outer face of the tooth holder in order to electrically conductively connect the further electrical bridge to the further winding end of the winding.

In some embodiments, at least one centring and/or fixing projection, which is formed in the radial direction of the tooth holder, is formed on the outer face. In some embodiments, the stator has a housing and the tooth holder is arranged in the housing, wherein the tooth holder is arranged in the housing in a manner fixed in terms of position and rotation by means of the at least one centring and/or fixing projection. The tooth holder can therefore be arranged in the housing fixed in terms of position in a simple and inexpensive manner. The centring projection may be formed in one piece with the tooth holder. The tooth holder and the centring projection can therefore be produced in one work step. In some embodiments, an annular space between an inner lateral surface of the housing and the outer lateral surface of the tooth holder is potted. In this way, increased thermal connection of the stator to the housing of the stator can firstly be provided by means of the potting material. Secondly, fixing of the stator in terms of rotation in relation to the housing can be increased by means of the potting material.

Some embodiments include an axial flux machine for a motor vehicle having a stator as described herein. The axial flux machine is designed and/or formed to at least partially electrically drive a motor vehicle. The axial flux machine may be a constituent part of a traction drive of the motor vehicle.

Some embodiments include a motor vehicle having an axial flux machine as described herein. The motor vehicle is an at least partially electrically driven motor vehicle and the axial flux machine is positioned in the drive train of the motor vehicle.

It should be noted that all features described above and below with respect to one aspect apply equally to any other aspect. In particular, all features of the stator may also be features of the axial flux machine and/or of the motor vehicle. This also applies conversely.

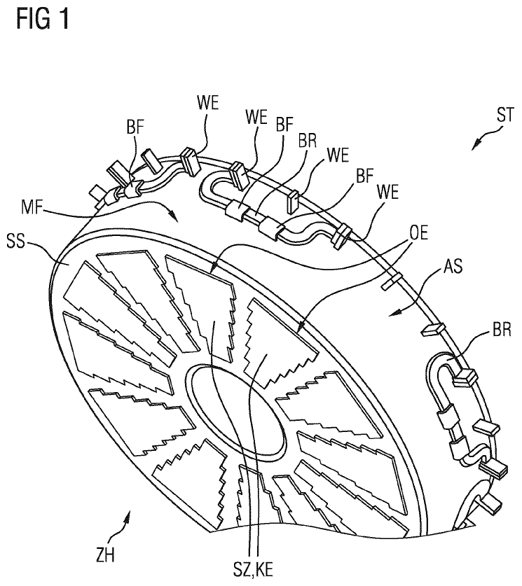

FIG. 1 shows a three-dimensional view of an example stator ST incorporating teachings of the present disclosure for an axial flux machine AFM. The stator ST has an annular tooth holder ZH. The tooth holder ZH comprises an end face SS and an outer lateral surface MF which is joined to the end face SS and runs in the circumferential direction of the tooth holder ZH. The end face SS and the outer lateral surface MF are connected to each other. In the present embodiment, the end face SS and the outer lateral surface MF are formed in one piece. Therefore, the structural rigidity of the tooth holder ZH can be increased. The end face SS has at least two openings OE, wherein the respective opening OF is formed for receiving a stator tooth SZ. The openings OE are closed at the edge and pass through the end face SS. The outer lateral surface MF has an outer face AS, which is directed outwardly in relation to the radial direction of the tooth holder. A bridge guide BF is formed, at least in portions, on the outer face AS.

Furthermore, the stator ST has at least two stator teeth SZ. From amongst the two stator teeth SZ, in each case one is arranged in one of the openings OE or engages, at least in portions and/or partially, in the opening OF. Each stator tooth SZ has a core KE and a winding WI which is wound onto the core KE and has at least one winding end WE. The respective winding end WE is guided in the radial direction of the tooth holder ZH until it is above the outer lateral surface MF.

An electrically conductive bridge BR for electrically connecting the winding end WE of the stator tooth SZ to the winding end WE of the further stator tooth SZ is arranged in the bridge guide BF, which is formed on the outer face AS of the tooth holder ZH. The electrically conductive bridge BR is positioned and/or fixed on the outer face AS of the tooth holder ZH by means of the bridge guide BF, so that the bridge is held fixed in terms of position for a connection operation with the winding end WE. This may have an advantageous effect on the production process.

The electrically conductive bridge and the winding end may be connected to each other via a materially bonded connection, in particular via a welded connection.

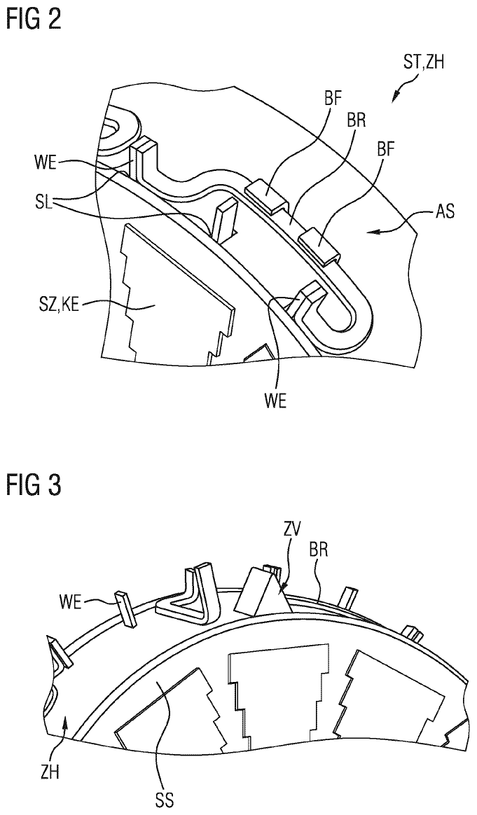

FIG. 2 shows a view of a detail of the stator ST in the region of the bridge guide BF. The outer lateral surface MF has at least one slot SL on a side which faces away from the end face SS. The winding end WE of winding WI is guided in the slot SL. In this way, the winding end WE of the winding WI can be guided in a simple and space-saving manner through the lateral surface MF until it is above the outer face AS of the outer lateral surface MF, in order to be connected to the electrical bridge BR there.

In this example, the bridge guide BF is of L-shaped form. It is provided here that the short web of the “L” is joined to the outer face AS in the radial direction of the tooth holder ZH, and the respectively other web, i.e. the long web of the “L”, is preferably oriented parallel to the longitudinal direction of the circular tooth holder ZH. Therefore, the electrically conductive bridge BR can be inserted and clamped between the outer face AS and the long web in parallel to the longitudinal direction of the tooth holder ZH. Therefore, a bridge guide BF which can be produced in a simple manner and at reasonable cost and allows the electrical bridge BR to be fixed on the outer face AS in a simple and straightforward manner is specified.

FIG. 3 shows a view of a detail of the stator ST in the region of a centring projection ZV. The stator ST has at least one centring and/or fixing projection ZV, which is formed in the radial direction, on the outer face AS. The centring projection ZV is formed in one piece with the tooth holder ZH. The tooth holder ZH and the centring projection ZV can therefore be produced in one work step.

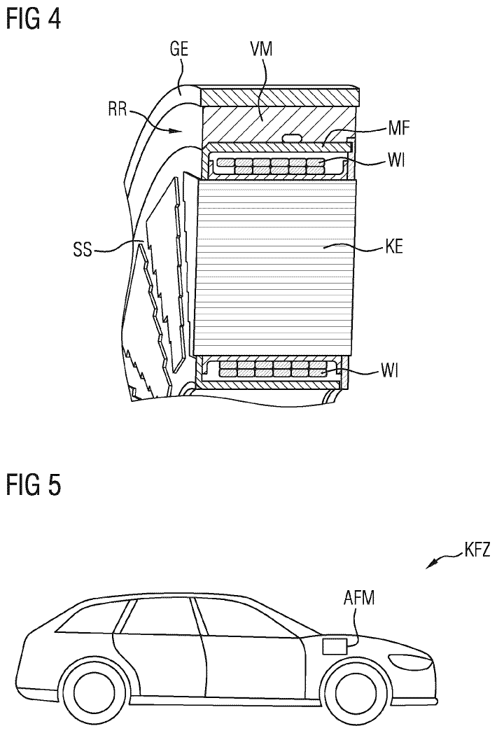

FIG. 4 shows a section through the stator ST, where the stator ST is arranged in a housing GE. An annular space RR between an inner lateral surface of the housing GE and the outer lateral surface AF of the tooth holder ZH is potted with a potting material VM. In this way, increased thermal connection of the stator ST to the housing GE can firstly be provided by means of the potting material VM. Secondly, fixing of the stator ST in terms of rotation in relation to the housing GE can be increased by means of the potting material VM.

FIG. 5 shows a motor vehicle KFZ having the axial flux machine AFM, which includes a stator ST incorporating teachings of the present disclosure. The axial flux machine AFM is positioned in the drive train of the motor vehicle KFZ.

1. A stator comprising:
an annular tooth holder with an end face having at least two openings to receive one stator tooth each, and has an outer lateral surface joined to the end face, and a bridge guide formed on an outwardly directed outer face of the outer lateral surface in the radial direction of the tooth holder;
two stator teeth, arranged, at least in portions, in respective openings, wherein each stator tooth has a core and a winding wound onto the core and at least one winding end guided in the radial direction of the tooth holder it is above the outer lateral surface; and
an electrically conductive bridge BRYTY is arranged in the bridge guide to electrically connect the winding end of the respective stator tooth to the winding end of the further stator tooth.

2. The stator as claimed in claim 1, wherein the bridge guide is of U-shaped and/or L-shaped form.

3. The stator as claimed in claim 1, wherein the tooth holder is formed in one piece.

4. The stator as claimed in claim 1, wherein the tooth holder comprises a plastic.

5. The stator as claimed in claim 1, wherein the outer lateral surface a slot on a side facing away from the end face and the winding end is guided in the slot.

6. The stator as claimed in any claim 1, further comprising a further bridge guide on the outer face and spaced apart from the bridge guide in the radial direction of the tooth holder.

7. The stator as claimed in claim 6, further comprising a further electrically conductive bridge is arranged in the further bridge guide and providing an electrically conductive connection to at least one further winding end of the winding.

8. The stator as claimed in any claim 1, further comprising at least one centring and/or fixing projection whichis-formed in the radial direction on the outer.

9. The stator as claimed in claim 8, further comprising a housing; and
Wherein the tooth holder is arranged in the housing fixed in terms of position and rotation by means of the at least one centring and/or fixing projection.

10. The stator as claimed in claim 9, wherein an annular space between an inner lateral surface of the housing and the outer lateral surface of the tooth holder is potted with a potting material.

11. An axial flux machine for a motor vehicle, the axial flux machine comprising;
a stator with:
an annular tooth holder with an end face having at least two openings to receive one stator tooth each, an outer lateral surface joined to the end face, and a bridge quide formed on an outwardly directed outer face of the outer lateral surface in the radial direction of the tooth holder;
two stator teeth arranged, at least in portions, in respective openings, wherein each stator tooth has a core and a winding wound onto the core and at least one winding end guided in the radial direction of the tooth holder above the outer lateral surface; and
an electrically conductive bridge arranged in the bridge quide to electrically connect the winding end of the respective stator tooth to the winding end of the further stator tooth.

12. A motor vehicle comprising:
an axial flux machine having a stator including:
an annular tooth holder with an end face having at least two openings to receive one stator tooth each, an outer lateral surface joined to the end face, and a bridge quide formed on an outwardly directed outer face of the outer lateral surface in the radial direction of the tooth holder;
two stator teeth arranged, at least in portions, in respective openings, wherein each stator tooth has a core and a winding wound onto the core and at least one winding end guided in the radial direction of the tooth holder above the outer lateral surface; and
an electrically conductive bridge arranged in the bridge guide to electrically connect the winding end of the respective stator tooth to the winding end of the further stator tooth.
